(19) United States
(12) Patent Application Publication
(10) Pub. No.: US 2012/0311509 A1
(43) Pub. Date: Dec. 6, 2012

(54) READER WITH ENHANCED USER FUNCTIONALITY

(75) Inventors: Richard A. Maggiotto, San Francisco, CA (US); Keith B. Nichols, Novato, CA (US); Matthew G. Davis, San Francisco, CA (US)

(73) Assignee: ZINIO, LLC, San Francisco, CA (US)

(21) Appl. No.: 13/444,059

(22) Filed: Apr. 11, 2012

Related U.S. Application Data
(60) Provisional application No. 61/473,929, filed on Apr. 11, 2011.

(51) Int. Cl. G06F 3/03

(52) U.S. Cl. 715/863

(57) ABSTRACT

A bookmarking system including a reader interface configured to cause content to be displayed on an electronic device having a touch-sensitive screen. The system includes a bookmark module configured to add a bookmark when a user swipes downwardly on the screen, wherein the bookmark is a record relating to the content displayed on the screen during the downward swipe.

This application claims priority to U.S. Provisional Patent Application Ser. No. 61/473,929, filed on Apr. 11, 2011, the entire contents of which are incorporated by reference herein.

The present invention is directed to an electronic reader, and more particularly, to an electronic reader which provides enhanced features and functionality.

### BACKGROUND

Electronic readers are utilized by users of electronic and mobile devices, such as desktop and laptop computers, mobile phones, mobile internet devices, tablets and tablet computers, personal electronic devices, electronic books, and the like. Such readers provide a user interface which a user can interact with to view content stored on, or streamed to, the associated device. However, existing readers lack certain features and functionalities which can provide an improved reading, viewing and interactive experience.

### SUMMARY

In one embodiment, the present invention is a bookmarking system including a reader interface configured to cause content to be displayed on an electronic device having a touch-sensitive screen. The system includes a bookmark module configured to add a bookmark when a user swipes downwardly on the screen, wherein the bookmark is a record relating to the content displayed on the screen during the downward swipe.

In another embodiment the invention is a clipping system including a reader interface configured to cause content to be displayed on an electronic device having a touch-sensitive screen. The system includes a clipping module configured to clip a portion of content displayed on the screen when a user forms a generally closed loop on the screen about the clipped content.

In another embodiment the invention is a wishlisting system including a reader interface configured to cause content to be displayed on an electronic device having a touch-sensitive screen. The system includes a wishlist module configured to store an identifier of a content item when a user identifies the desired content item using the touch-sensitive screen.

In yet another embodiment, the invention is a social network interface system including a reader interface configured to cause content to be displayed on an electronic device. The system includes a social network module configured to, when a user carries out at least one predetermined activity, automatically query a user about sending information relating to the displayed content to a social network, or to automatically send information relating to the displayed content to a social network.

### BRIEF DESCRIPTION OF DRAWINGS

FIG. 1 is a screen shot of a reader showing a mosaic view of various content items;

FIG. 2 is a screen shot of a reader showing the front page of a selected content item;

FIG. 3 is a screen shot of a reader displaying a page of content of a selected content item;

FIG. 4A illustrates a gesture for adding a bookmark;

FIG. 4B illustrates a gesture for removing a bookmark;

FIG. 5 is a screen shot of a reader showing a bookmark creation window;

FIG. 6 is a screen shot of a reader showing the bookmark creation window of FIG. 5 with a keyboard;

FIG. 7 is a screen shot of a reader showing a control window;

FIG. 8 is a screen shot of a reader showing a bookmark display window;

FIGS. 9A-9C illustrate a set of gestures for adding a clipping;

FIG. 10 is a screen shot of a reader showing a clipping creation window;

FIG. 11 is a screen shot of a reader showing a clipping display window;

FIG. 12 is a screen shot of a reader displaying a selected clipping;

FIG. 13 is a screen shot of a reader showing a set of content items;

FIG. 14 is a screen shot of a reader showing further details relating to a selected content item;

FIG. 15 is a screen shot of a reader displaying a wishlist;

FIG. 16A illustrates a gesture for activating a sharing functionality;

FIG. 16B shows user selecting an item from a sharing identity window which may appear in response to the gesture of FIG. 16A;

FIG. 17 illustrates a sharing information window;

FIG. 18 illustrates an alternate sharing information window;

FIG. 19 is a screen shot of a reader showing a settings window;

FIG. 20 illustrates a sharing settings window;

FIG. 21 illustrates a sharing prompt window;

FIG. 22A illustrates a gesture for activating a sharing functionality; and

FIG. 22B shows a sharing window which may appear in response to the gesture of FIG. 22A.

### DETAILED DESCRIPTION

### 1. Definitions

Prior to describing the present system and method in greater detail, certain terms used herein will first be defined. “Computer” means computers, laptop computers, computer components and elements of a computer, such as hardware, firmware, virtualized hardware and firmware, combinations thereof, or software in execution. One or more computers can reside in or on a server in various embodiments and the server can itself be comprised of multiple computers. One or more computers can reside within a process and/or thread of execution, and a computer can be localized at one location and/or distributed between two or more locations.

“Mobile device” means a handheld, stationary (i.e. placeable on a table-top), manually carryable or wearable electronic device which can receive electronic data, digitized inputs and/or provide electronic or digitized outputs or displays, such as mobile phones, cellular phone, mobile internet devices, tablets and tablet computers (such as Apple's iPad®, BlackBerry's PlayBook™, Motorola's Xoom™, Nokia's Maemo®, Hewlett Packard's Slate 500™, Acer's Iconia®), personal electronic devices, electronic books (such as Amazon's Kindle®, Barnes & Noble's Nook™ and Sony's PRS-500™), electronic book readers, electronic organizers, personal digital assistants, or the like.

“Device” or “Electronic Device” means a computer and/or mobile device.

“Computer communications” means communication between two or more devices, and can take the form of, for example, a network transfer, a file transfer, an applet transfer, an email, a hypertext transfer protocol (“HTTP”) message, a datagram, an object transfer, a binary large object (“BLOB”) transfer, and so on. Computer communication can occur across a variety of mediums by a variety of protocols, for example, a wireless system (e.g., IEEE 802.11), an Ethernet system (e.g., IEEE 802.3), a token ring system (e.g., IEEE 802.5), a local area network (“LAN”), a wide area network (“WAN”), BLUETOOTH® communications, a point-to-point system, a circuit switching system, a packet switching system, wireless, cellular or satellite communication systems, and various other systems.

“Software” means one or more computer readable and/or executable instructions or programs that cause a device to perform functions, actions and/or behave in a desired manner. The instructions may be embodied in various forms such as routines, algorithms, modules, methods, threads, and/or programs. Software may also be implemented in a variety of executable and/or loadable forms including, but not limited to, stand-alone programs, function calls (local and/or remote), servelets, applets, instructions stored in a memory, part of an operating system or browser, bytecode, interpreted scripts and the like. It should be appreciated that the computer readable and/or executable instructions can be located on one device and/or distributed between two or more communicating, co-operating, and/or parallel processing devices or the like and thus can be loaded and/or executed in serial, parallel, massively parallel and other manners. It should also be appreciated that the form of software may be dependent on various factors, such as the requirements of a desired application, the environment in which it runs, and/or the desires of a particular designer/programmer.

“Webpage” means any document written or encoded in a mark-up language, or dynamically created by software including, but not limited to, hypertext mark-up language (“HTML”), virtual reality modeling language (“VRML”), dynamic HTML, extended mark-up language (“XML”) or related computer languages and scripts, including scripts and other resources contained with a mark-up language shell such as FLASH® or JAVASCRIPT® applets, as well as any collection of documents reachable through one specific Internet address or at one specific website, or any document obtainable through a particular uniform resource locator. The software may be embodied in a (tangible, in some cases) computer-readable medium, such as a magnetic storage devices (hard disk drives or the like), optical drives, flash memory, etc.

“Website” means at least one webpage, or a plurality of webpages, virtually linked to form a coherent group.

“Web browser” means any software program running on a device which can display text, graphics, video, images, sound, music or the like from webpages or websites. Examples of commercially available web browsers include, without limitation, MICROSOFT® INTERNET EXPLORER®, MOZILLA® FIREFOX®, APPLE® SAFARI®, GOOGLE® CHROME™, OPERA™ browsers, and the like.

“Web server” means a computer, device, computers, or software configured to operate at least in part as a server capable of serving or providing information associated with at least one webpage to a web browser at the request of a user.

“Database” means any of a number of different data stores that provide searchable indices for storing, locating and retrieving data, including without limitation, relational databases, associative databases, hierarchical databases, object-oriented databases, network model databases, dictionaries, flat file/XML datastores, flat file systems with spidering or semantic indexing, and the like.

### 2. Overview

The reader described herein may take the form of software which provides a user interface or reader interface which users can interact with to thereby view content stored on, or streamed to, an associated device. The content can take any of wide variety of forms, such as text, images, video and multimedia content, magazines, periodicals, books, articles, movies, audiovisual clips, animated visual displays, sounds, music, or the like. The reader may be part of a larger program which can provide various other functionalities, such as enabling a user to download, view or access content, purchase content, manage subscriptions, explore free or paid content, preview content, manage user preferences, track user activities, create and manage user accounts, organize content, manage advertising models, and the like, such as a system disclosed in U.S. Pat. No. 7,290,285, the entire contents of which are hereby incorporated by reference.

The reader can include a reader interface which carries out the functions described above, and displays content to a user. In one case the reader interface can be the operating system of a device or part thereof. The reader interface may include functionality for displaying a wide variety of files, data or content, for example, ePub files (compliant with the standards created by the International Digital Publishing Forum (IDPF)), .pdf files, files in KF8 and AZW format, IBA files, etc. The reader interface may include software that is or structurally similar to Adobe Digital Additions, EPUBReader, Google Books, iBooks, NOOK for Mac, etc. Moreover, it should be understood that the reader described herein need not necessarily be part of a larger program/software, but could instead take the form of a stand-along software/program providing all or some of the functionality or features described herein.

The reader may reside on a computer/server which is accessed by a user or device when a user navigates to a webpage or a website on a device via a web browser. Alternately, the reader, or portions thereof, may reside on the user's device, including but not limited to as an app or part of an app which a user can activate/access by tapping or otherwise selected an icon associated with the app. The content that is usable in conjunction with reader can be provided by computer communications and stored at the same server/computer as the reader, or stored at a different computer/server, or stored on the user's device, or stored elsewhere. The user may have certain content which the user is entitled to view due to paid subscription fees, or be provided free and/or limited access to the content, or be provided access under other content models.

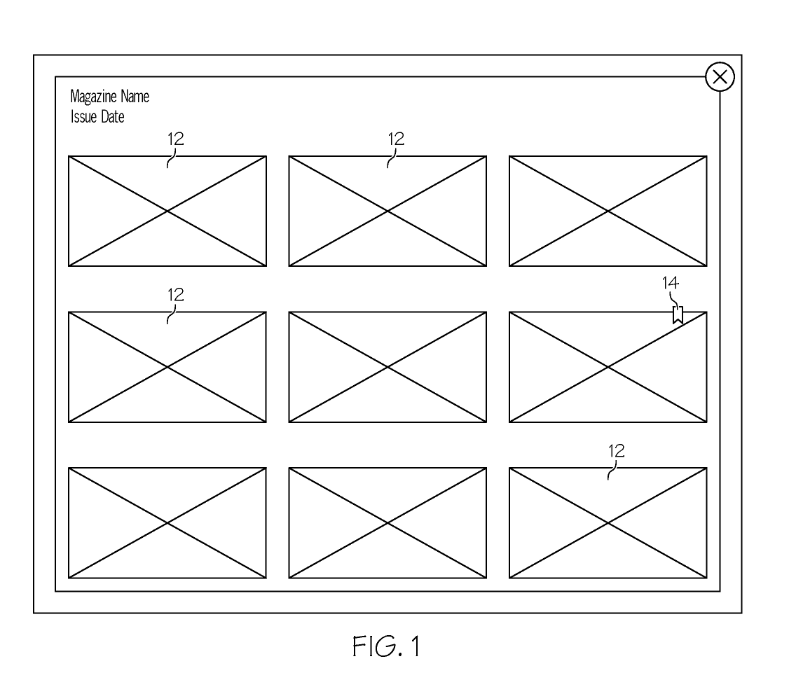

Once the user has accessed the desired content via the reader, the user may navigate in various manners to display/view the content. For example, FIG. 1 is a screen shot of a device using the reader and showing a mosaic or content display view in which a user is presented with various images, each associated with particular content item 12. For example, in the embodiment of FIG. 1, each “x-ed out” rectangle represents a discrete content item 12. Each content item 12 may represent, for example, a book, a particular issue of the magazine, an article, etc. The associated, displayed image 12 may correspond to the cover of the book, the cover of the magazine, or some other corresponding image. However, for ease of illustration, each image/content item 12 in FIG. 1 is shown as a rectangle with an “x” inside, rather than a particular image, and this convention will be followed throughout the rest of the drawings for this patent application. It should also be noted that the screen shot shown in FIG. 1 and throughout this application are generally shown in landscape orientation. However, the reader may also function in portrait or other orientations, and may provide displays that can switch between various orientations depending upon the user's desires and the positioning of the device.

In order to view a content item 12 shown in the screen of FIG. 1, a user selects the desired content item. In one embodiment, the device includes a touch screen, touch-sensitive screen, pressure-sensitive screen, heat-sensitive or conductivity-sensitive screen (collectively termed a touch-sensitive screen herein) such that the user may simply touch the associated content item 12. However, the content item 12 can be selected by various other means, such as by use of a mouse, track ball, touch pad or other cursor control device, keyboard, drop-down or pop-up menus, keyboard shortcuts, etc.

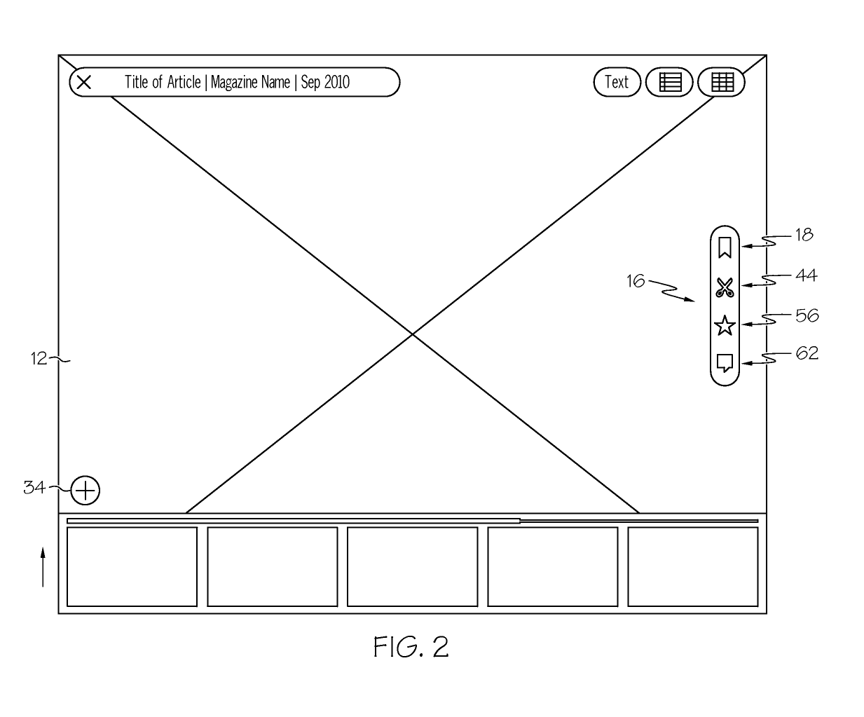

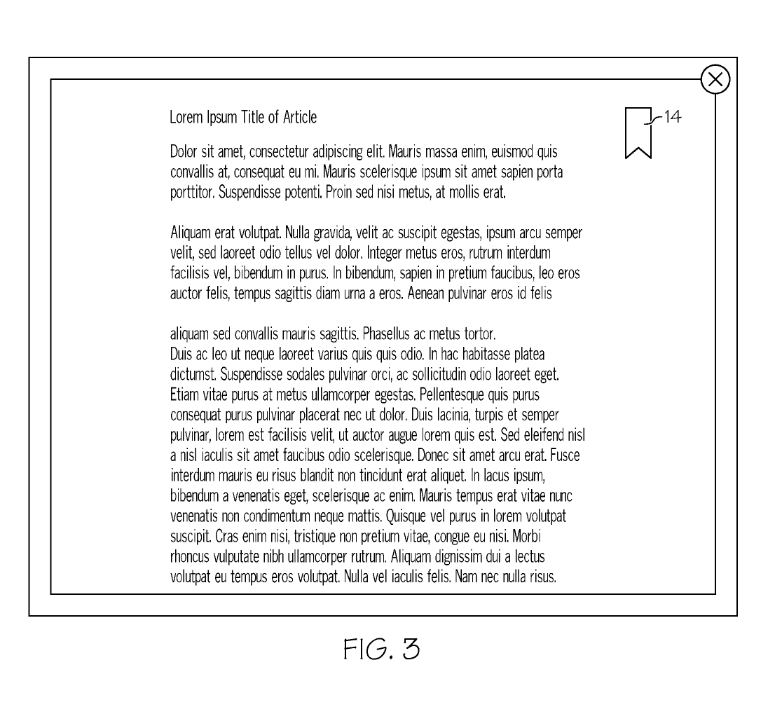

Once the particular content item 12 has been selected, the content may then be accessed, downloaded or streamed to the device so the user can view the content. If the content item is, for example, a magazine, article or book, a user may then be presented with the associated text, images and the like. FIG. 2 is a screen shot in which the cover or front page of the selected content item is displayed to the user. FIG. 3 illustrates one particular embodiment in which a page of content of the selected content item 12 is displayed for viewing/reading by the user. The user can navigate the content by any wide variety of means, such as, for example, reading the items in page order, browsing a table of contents, jumping to a particular location, searching for particular content, etc. The user can page through the content by simply touching the screen, selecting an arrow, swiping laterally across the screen, or by any of a wide variety of other well-known content-navigating methods and means.

### 3. Bookmarks

When a user is viewing and/or reading particular content, the user may wish to bookmark a particular item of content 12, an article, or a particular location within an item of content 12 or article. In particular, a user may find some of the content to be of particular interest to be marked for later review, or to mark the extent of the user's reading. This functionality, as well as the functionality described below, may be carried out by a bookmark/bookmarking module that is operatively connected to the reader and/or part of the reader/system/software.

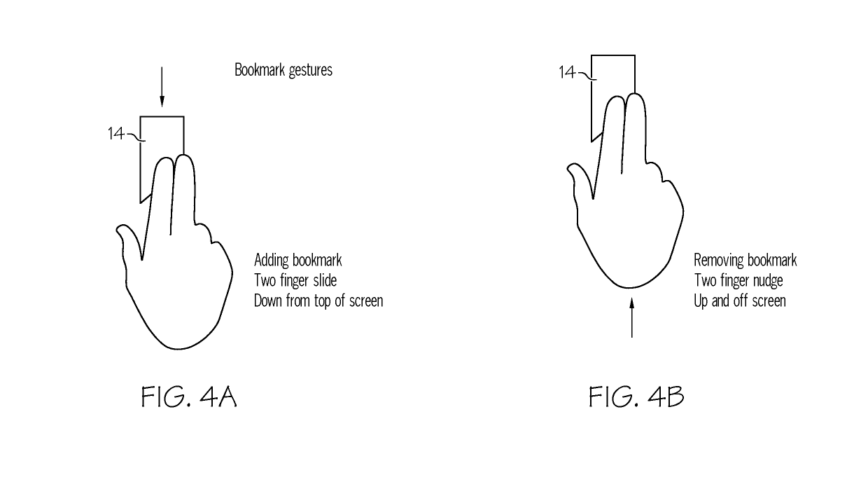

The reader/bookmark module may be configured to enable a user to add a bookmark by any of a variety of means, including by use of a gesture when the device has a touch-sensitive screen or display. In particular, as shown in FIGS. 4A and 4B, in one case a bookmark 14 can be added when the user swipes two fingers downwardly from the top portion of the device's screen. In this case, in particular, the reader/bookmark module may be programmed to sense or recognize a downward-swipe motion. In some cases, the downward-swipe motion may be required to be in a particular location of the screen to be recognized as an indication/request to add a bookmark. For example, in one case the downward-swipe motion must be in the upper quarter, or upper eighth (or some other fraction or area) of the screen of the device, or within some distance (i.e. within about 2 inches) of particular edges of the screen (i.e. top and/or right edge). Alternately, however, the downward-swipe motion may be able to be carried out at any position on the screen.

The downward-swipe motion may also be required to be recognized as two parallel but spaced apart downward swipes. The downward swipes may also be required to extend downwardly only a relatively short distance, such as, for example, between about ¼ inch and 1 inch in one case, and may be required to be spaced apart by between about a quarter inch and about 1 inch. Alternately, rather than looking for two spaced-apart swipes, a sufficiently wide swipe (i.e. a swipe generally corresponding to the width of two fingers; at least about one inch in one case) may suffice, particularly if the touch screen is of a low touch sensitivity resolution.

Bookmarks 14 may also be able to be added by various other means besides gesture-based logic/commands, such as by navigating via a keyboard, using drop-down or pop-up menus, by a mouse, track ball, touch pad or other cursor-control device, keyboard shortcuts, etc. For example, in one case, as shown in FIG. 2, a navigation panel 16, which may pop-up or otherwise provided on the screen (and potentially overlying the displayed content), has a bookmark icon 18 which the user can activate to indicate a desire to add a bookmark to a particular location of the displayed content.

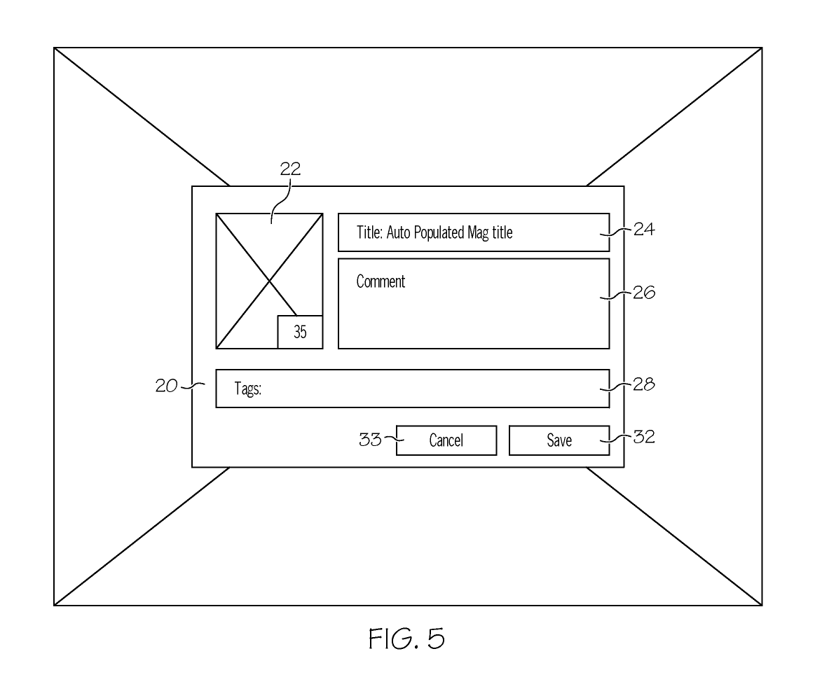

Once the reader/bookmark module receives or processes an indication that a user wishes to add a bookmark, a bookmark creation window 20 may appear as shown in FIG. 5. In the illustrated embodiment the bookmark creation window 20 is a pop-up window, appearing over the displayed content which is to be bookmarked. As can be seen, the bookmark creation window 20 includes an image 22, a title field 24, a comment field 26 and tag field 28, although more, less, or different fields may be provided. The image field 22 may correspond to the content item 12 into which the bookmark is to be added, and can be the same image 12 displayed in the mosaic or content display screen of FIG. 1. For example, the image field 22 can correspond to the cover of the magazine or book. Alternately, or in addition, the image field 22 can correspond to an image of the location where the bookmark is to be added. The title field 24 may be manually or auto-populated with the title of the content (i.e. the magazine or book title), but may also be able to be modified by the user. The comment field 26 allows a user to add any desired comments associated with the bookmark (i.e. “Last read”, or “Of interest to Mark,” etc.)

Finally, the tag field 28 may be manually or auto-populated with tags that describe the content, category or type of content item, the nature of the bookmark, time/date stamp information, user information etc. The tag field 28 (and other tag field utilized herein) can be used to store tag that are searchable by a user. For example, when a user searches for a tag, all of the bookmarks (or clippings or wishlist items, as described below, or other data/content) or other content tagged with the tag may be displayed and able to be selected by the user.

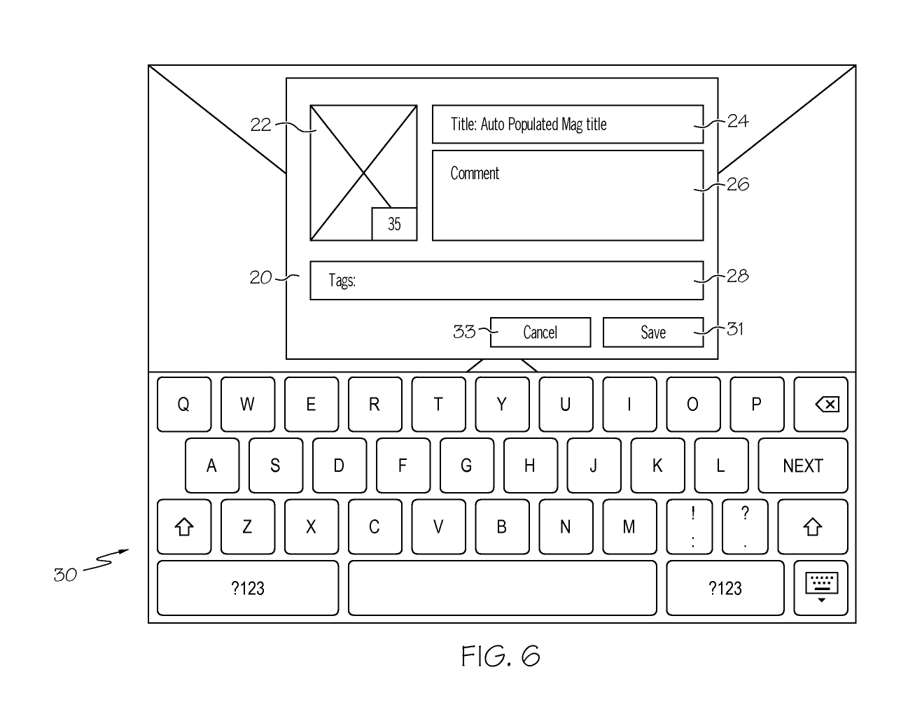

If a user wishes to enter and/or modify text/content in one or more of the fields 22, 24, 26, 28, the user may touch, click on or otherwise activate a field, which can cause a touch-activated keyboard 30 to pop up (if not already present) as shown in FIG. 6. The user can then add text to the comment field 26 or modify the title 24 and/or tag 28 fields as desired. In some cases, the user may also be able to change the image 22, for example, by selecting a substitute image, such as an image stored in the device, or saved or viewed from other source.

Once the user is done making changes via the bookmark creation window 20 (or if no changes are desired), the user selects the “save” field 31 of the bookmark creation window 20, and the bookmark information is stored, including the identification of the content item 12 (i.e. its title, publication issue, folio number, date, author, subject, etc.), location of the bookmark, date of creation, comments, tags, associated image, etc. The bookmark information can be stored on the user's device, or stored at the same server/computer as the reader, or stored at the same server/computer which provided the associated content, or stored elsewhere. The bookmark creation window 20 then closes, and the user can be returned to the original reading location. If desired, the user can abort the bookmark creation process by selecting the cancel button 33.

Once the bookmarking process is complete, a bookmark marking, logo or indicia 14 may be added at the appropriate location in the content, as shown in FIG. 3. In this case the bookmark logo provides a persistent visual representation of the bookmark when the content is viewed. In the illustrated embodiment, the bookmark logo 14 is placed in the upper-right corner or quadrant of the screen/content when the content is displayed, although the bookmark logo 14 can be displayed at other positions. Moreover, when a particular content item 12 has a bookmark added to it, the content item 12 may be displayed with a bookmark icon 14 associated therewith as shown, for example, in the content display/selection view of FIG. 1. In this manner the user is informed that a particular content item 12 has at least one bookmark 14.

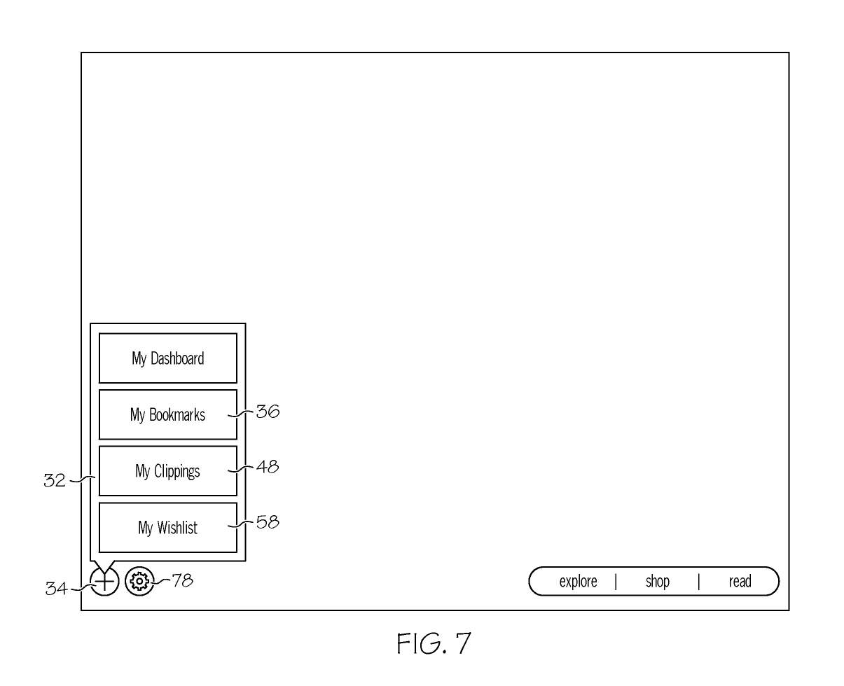

The reader/bookmark module stores the various bookmarks associated with the user such that the bookmarks can later be recalled and viewed as a group. For example, as shown in FIG. 7, the reader may include a pop-up control window 32 which can be activated by activating the “+” button 34 of the reader. The resultant control window 32 may include a selectable item entitled “My Bookmarks” 36 which, when selected by the user, causes the bookmarks stored by that user to be displayed as shown, for example, in FIG. 8. In this particular embodiment, all of the bookmarks 14 created by the user are displayed in a new pop-up bookmark display window 38, including for example the title of the bookmark, the date of creation, the associated image 22 and optionally the tags. Selectable buttons 40 are provided in the bookmark display window 38 such that the displayed bookmarks 14 can be sorted by date, title or tags. If desired, the user can select a particular bookmark 14 at that time. When a bookmark is selected in this manner, the reader is directed to the bookmarked location of the content such that the user may resume reading the content/magazine at that location.

The bookmark display window 38 (i.e. the “My Bookmarks” screen) may also include an edit function which can be activated, for example, by touching or activating the “edit” icon or field 42 displayed thereon. A displayed bookmark icon 14, as shown in FIGS. 1 and 3, may also be able to be tapped or otherwise selected to pull up the bookmark edit window. After a particular bookmark is selected for editing, a bookmark edit window, which can take the form of a window the same as or similar to the bookmark creation window 20 shown in FIG. 5, may be presented to the user such that the information relating to the bookmark can be edited and saved.

Bookmarks can also be removed by the user as desired, such as by gesture-based logic/commands. For example, when the user is presented with the particular page or display of content with a bookmark icon 14 displayed thereon, the user may be able to remove the bookmark by placing two fingers over or around the bookmark icon 14 (or other locations, if desired, including the areas described above in the context of adding a bookmark), and sliding upwardly, as shown in FIG. 4B. The reader/bookmark module uses logic and/or algorithms similar to those described above in the context of adding a bookmark (but looking for upward, instead of downward motion) to determine when a user desires to remove a bookmark. Moreover, the bookmark may be able to be removed by other means, such as by drop-down or pop-up menus, navigation via the keyboard, mouse, track ball, touch pad or other cursor control devices, keyboard shortcuts, etc.

As noted above, the bookmark feature can be useful to enable a user to track his or her progress, and mark items or passages of interest. Moreover, if desired the reader/bookmark module may track the user's bookmarks so that the reader can track which items of content 12, and which particular content, is bookmarked by a user, thereby indicating a particular interest. This information can be passed along as feedback to the owner/distributor of the content, or advertisers for targeting particular users, or to other parties. The reader can also use the bookmarking information to track the user's interests and suggest related items that may be of interest to the user to improve the user's experience.

### 4. Clipping

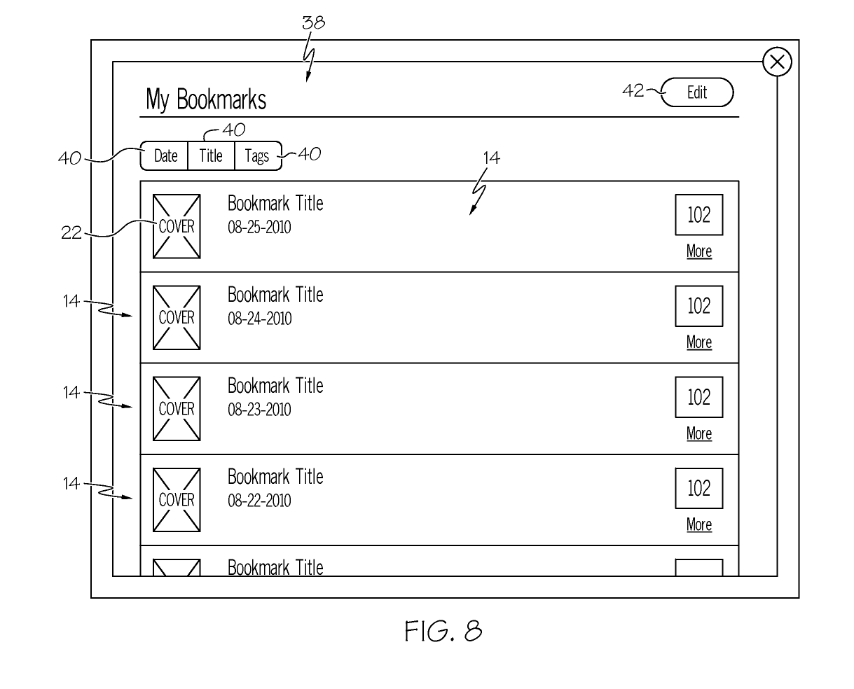

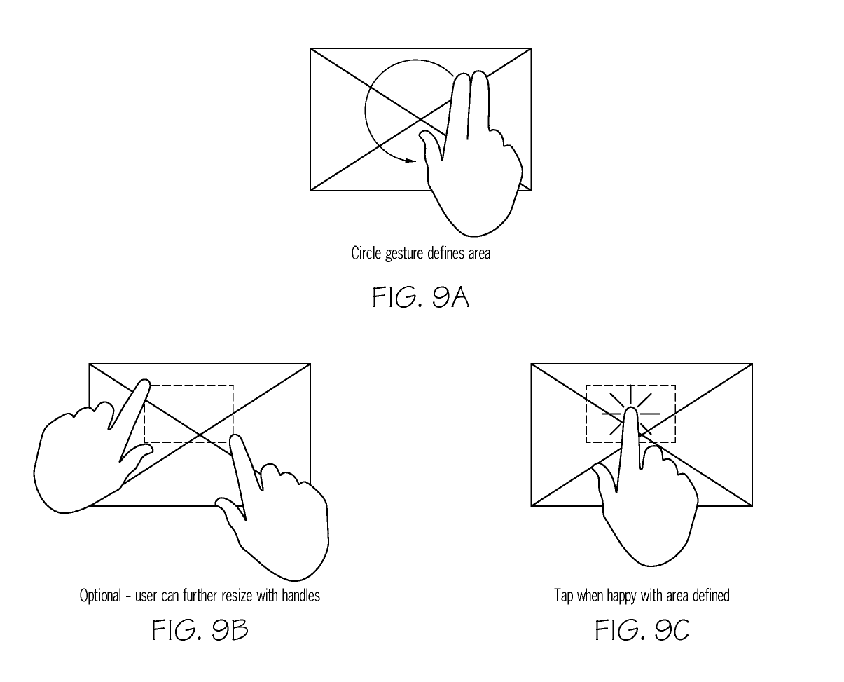

When a user is viewing and/or reading content, the user may wish to “clip” certain portions of the content such that the clipped content can be pasted, merged, forwarded, viewed, shared, organized or otherwise manipulated. This functionality, as well as the functionality described below, may be carried out by a clipping module that is operatively connected to the reader and/or part of the reader/system/software. In one case, in order to clip and identify the portion of the content to be clipped, the user can use particularized gestures to identify the portion of the content to be clipped. For example, as shown in FIG. 9A, when the reader is used in conjunction with a device having a touch screen, the user can draw a generally closed loop around the content to be clipped.

The reader/clipping module may be programmed to sense when a user makes a gesture which forms a closed or generally closed loop, indicating to a desire to create a clipping. In order to trigger the clipping function, the loop defined by the user may be required to have a certain minimum surface area such as, for example, at least about 1 square inch in one case. Moreover, a loop drawn by the user may be considered be completed when a line drawn by the user approaches or intersects the start point or a previously drawn portion of the line (i.e. intersects within about 1 square inch (after being outside the 1 square inch area); or about ½ square inch, or within about 1/10 of the perimeter of the line).

In some cases, the user may be required to draw the closed loop with two fingers. Thus, in this case, the reader/software may look for two parallel closed or generally closed loops, or a closed loop drawn with sufficiently thick “lines” corresponding to two finger thicknesses, using some of the same or similar parameters outlined above with respect to the bookmarking gestures.

After the loop is drawn, the loop may be recognized and/or displayed in its drawn shape. Alternately, the reader/clipping module may fit a best-fit polygon, such as a rectangle, to the loop defined by the user, using any of a wide variety of known best-fit polygon techniques/algorithms. The displayed rectangle defined by the loop may be displayed to the user for re-sizing by touching (or clicking) and dragging the corners of the rectangle, or by using other re-sizing techniques, as shown in FIG. 9B. Once the area of the clipping is re-seized to the desired dimensions, the user may be able to remove his or her fingers from the screen and/or click or activate a “save” button or the like, or simply touch the center of the clipping area to indicate a desire to save/close the clipping, as shown in FIG. 9C.

Clippings may also be able to be defined by various other means besides gesture-based logic/commands, such as by navigating via a keyboard, using drop-down or pop-up menus, by a mouse, track ball, touch pad or other cursor-control device, keyboard shortcuts, etc. In one case, as shown in FIG. 2, the navigation panel 18 has a clipping icon 44 which the user can activate to indicate a desire to create a clipping. Once the clipping icon 44 is activated, various graphical tools, which can be utilized by a user to define an area, may be provided, or the user may define a loop in the manner outlined above. For example, in one case a first point selected by the user is taken as an “anchor” point, and any movement away from the anchor point defines a circle/polygon of varying size based upon distance away from the anchor point.

Once the area defined by the user for clipping has been defined, the reader may display the clipped area in a separate window, highlight the clipped area, etc. For example, the content/text outside the loop may be blacked out/grayed out/not displayed, and/or the content/text inside the loop may be highlighted, shown in a pop-up window etc. The clipping can then be stored for later viewing, or forwarded to other programs or apps. for further use and/or manipulation.

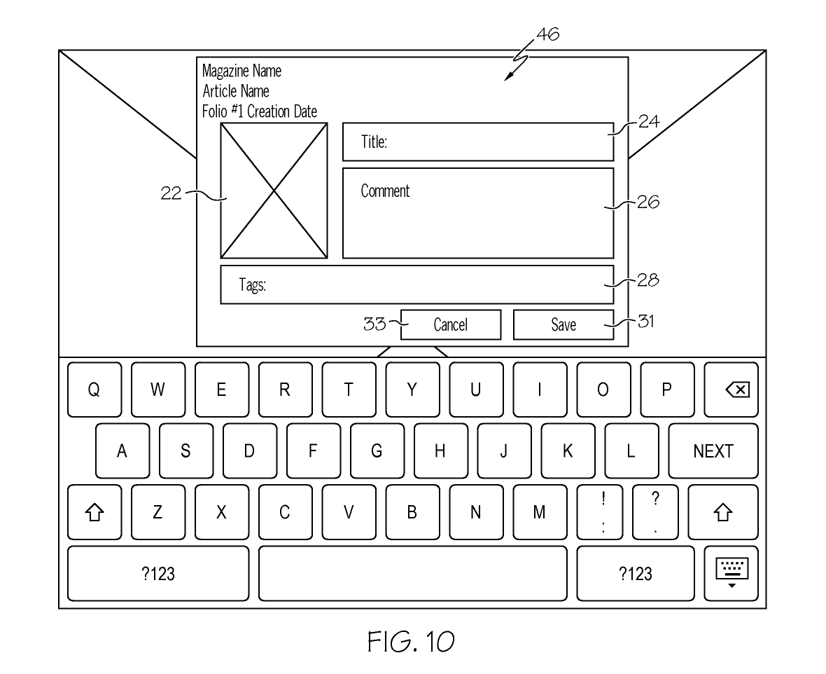

When the reader/clipping module receives or processes an indication that a user wishes to make a clipping, or after a clipping area is defined, a clipping creation window 46 may appear as shown in FIG. 10. The clipping creation window 46 can be similar to the bookmark creation window 20, and take the form of a pop-up window appearing over the content which has been clipped. The clipping creation window 46 may include an image 22, title field 24, comment field 26, tag field 28, save button 31 and a cancel button 33. The image 22, title 24 and/or tag fields 28 may be auto-populated as described above in the context of bookmarking In addition, the image 22, title 24, comment 26 and tag 28 fields may be able to be customized by a user. Once the user completes the clipping creation window 46, the user selects the save button 31, and the clipping information is stored, including an identification of the associated content item (such as publication title, publication issue, folio number, date, author, subject etc.), date of clipping, clipping name, tags, comments, associated image, etc. The clipping information can be stored on the user's device, or stored at the same server/computer as the reader, or stored at the same server/computer which provided the associated content, or stored elsewhere.

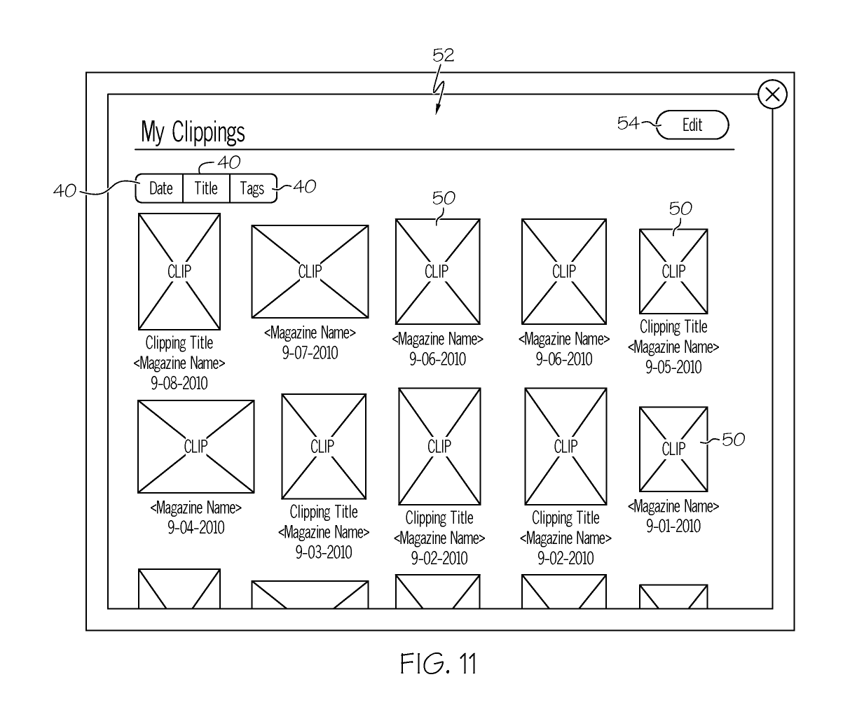

The reader/clipping module stores the various clippings such that the clippings can be later recalled and viewed as a group. For example, as shown in FIG. 7, the control window 32 activated by pressing on the “+” button 34 may include an icon entitled “My Clippings” 48 which can be selected by the user. When the “My Clippings” feature 48 is activated, a listing of the clippings 50 stored by the user are displayed in a clipping display window 52 as shown, for example, in FIG. 11. Buttons 40 are provided in the clipping display window 52 such that the display clippings can be sorted by date, title, tags, or other fields.

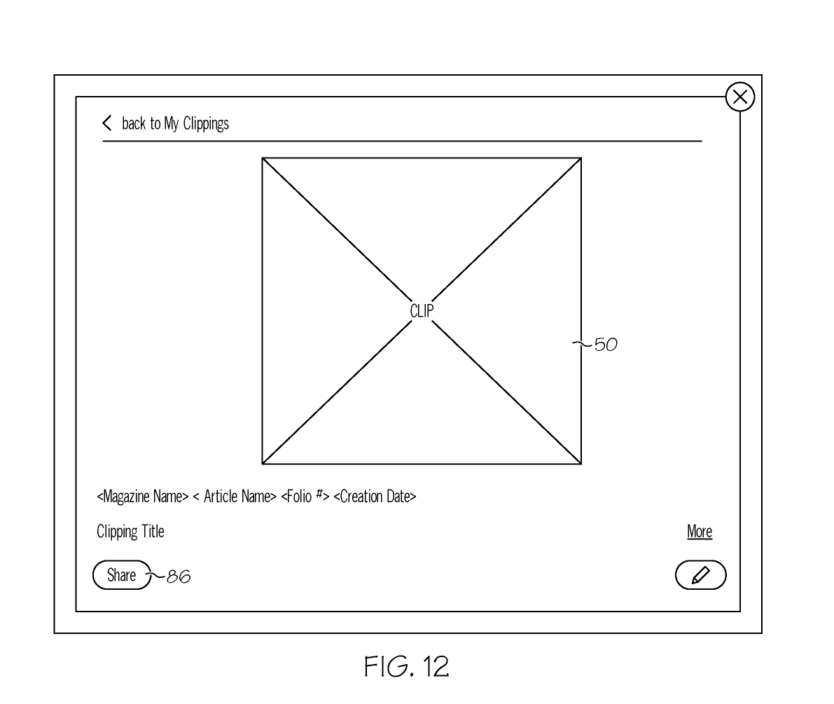

If desired, the user can select a particular clipping from the clipping display window 52, which causes the reader to display the content of the clipping. For example, FIG. 12 illustrates a window in which a selected clipping 50 is displayed, along with associated properties of the clipping, such as its title, source, creation date, etc. The properties and fields associated with each clipping 50 can be edited when the user selects the “edit” button 54 (FIG. 11) and chooses the desired clipping 50. After a particular clipping 50 is selected for editing, a clipping edit window, which may be similar to the clipping creation window 46 shown in FIG. 10, is presented to the user such that the associated information can be edited and saved.

As noted above, the clipping feature can be useful to a user to capture content that is of particular interest, and store the content to be recalled for later viewing or use. Moreover, if desired the reader/clipping module may track the user's clippings, such as the content and source of the clippings and other information. In this manner the reader can track which items of content, and which particular content, is of interest to a user. This information can be passed along to the owner/distributor of the content, or advertisers for targeting particular users, or others. The reader can also use the clipping information to track the user's interests and suggest related items that may be of interest to the user. The clipping functionality, or portions thereof, may be disabled if it appears that legal restrictions would prohibit clipping of certain content and/or digital right management software or algorithms may be utilized.

### 5. Wishlist

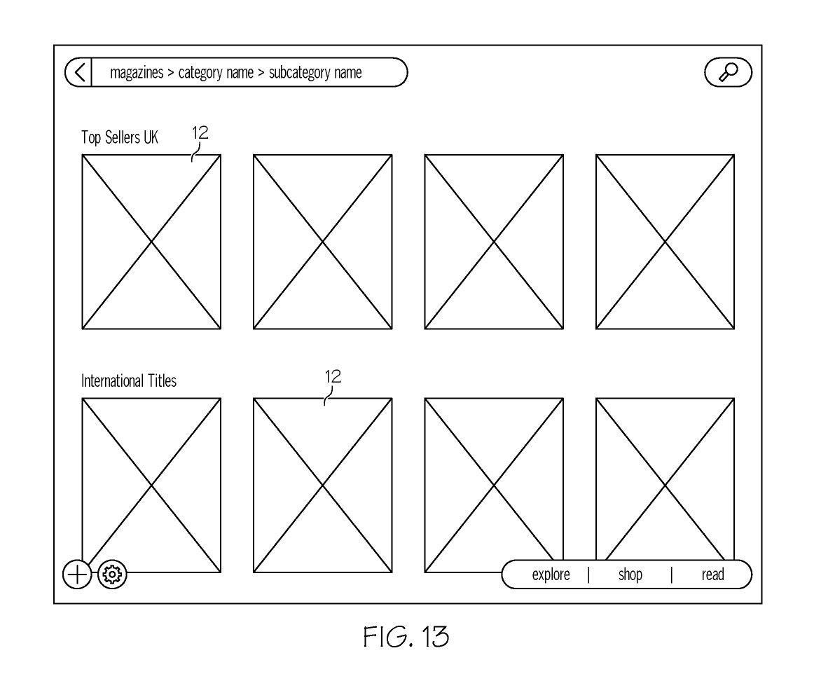

When a user is viewing or browsing content items, such as a listing of books, articles, magazines, movies, etc. for purchase, the user may wish to designate certain content items that the user would like to acquire or gain access to (i.e. by later purchase by the user, for notifying the user's acquaintances of gift ideas, etc.). This functionality, as well as the functionality described below, may be carried out by a wishlist/wishlisting module that is operatively connected to the reader and/or part of the reader/system/software. For example, in one case, when the user is browsing a set of magazines, articles or books available for purchase, as shown in FIG. 13, the user may wish to add certain of those items to the user's wishlist or wishlist database.

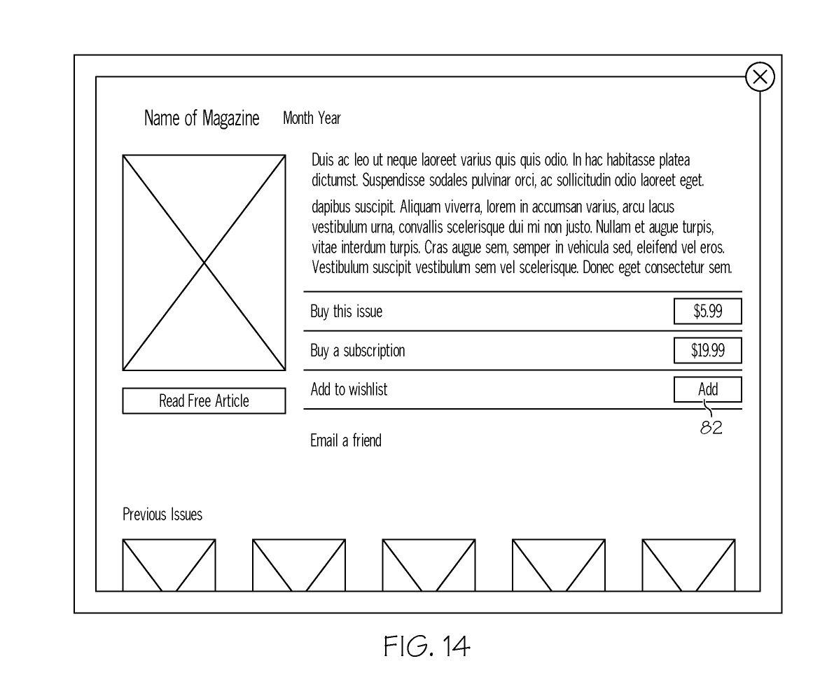

Content items (or a list/identity of content items) can be added to a user's wishlist or wishlist database by a variety of means, such as by touching on the content item 12 (when the device has a touch screen) by use of a keyboard, drop-down or pop-up menus, or by use of a mouse, track ball, touch pad or other cursor control device, keyboard shortcuts, gesture-based logic/commands (i.e. carrying out certain gestures on the portion of a screen displaying the content item 12), etc. In one case, content items 12 can be added to the wishlist by selecting the wishlist icon 56 from the navigation panel 16 of FIG. 2, and selected a content item either before or after the wishlist icon 56 is selected. After a content item 12 has been selected for adding to the wishlist or for potential purchase, the user/reader may be directed to a purchase screen, as shown in FIG. 14, which provides greater detail related to the content item 12, and offers the user an option to buy the content item, or add the content item to his or her wishlist. In this case the user can add the content item 12 to the wishlist by activating the “Add” button or icon 82.

The reader/wishlist module stores the wishlist items, including various details such as the identity of the content item, the time/date of adding to the wishlist, the user's identity, the context surrounding the addition of the content item to the wishlist (i.e. if the user was browsing a preview of the content item, or reading a related article, or received a recommendation, etc.) and the status of the wishlist item (e.g. unfulfilled/fulfilled). In some cases the reader/wishlist module maintains a list of all wishlist items such that the wishlist can later be recalled and viewed.

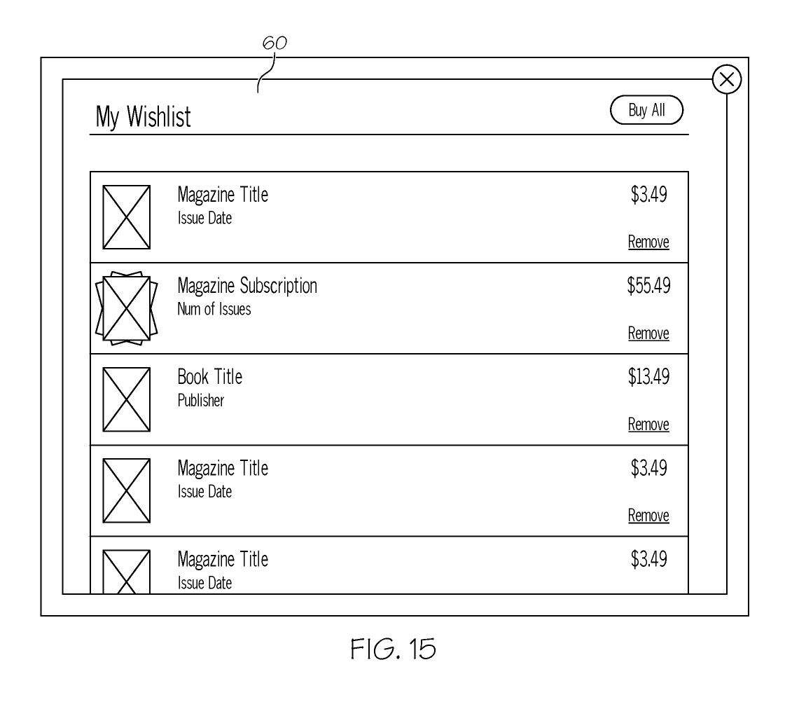

For example, returning to FIG. 7, as noted above the reader may be configured to display the control window 32 when the “+” button/icon of the reader is selected. The control window 32 includes a heading or icon entitled “My Wishlist” 58 which, when activated, causes all of the wishlist items associated with that user to be displayed. For example, a pop-up wishlist listing window 60, as shown in FIG. 15, may be provided. The wishlist listing window 60 provides details relating to the wishlist, such as the title of each content item 12, date of creation, associated image, price, tags and fields and the like which can be stored, edited, and displayed. Such details can also form the basis for sorting the displayed wishlist items similar to the concepts as described above for bookmarks and clippings. The wishlist information can be stored on the user's device, or stored at the same server/computer as the reader, or stored at the same server/computer which provided the associated content, or elsewhere

Similar to the bookmarking and clipping features, the reader/wishlist module may track the user's wishlist items so that the reader can track which items of content are of interest to a user. This information can be passed along as feedback to the owner/distributor of the content, or advertisers for targeting particular users, or tracked by the reader or others to study the user's interests and suggest related items that may be of interest.

### 6. Sharing/Social Media

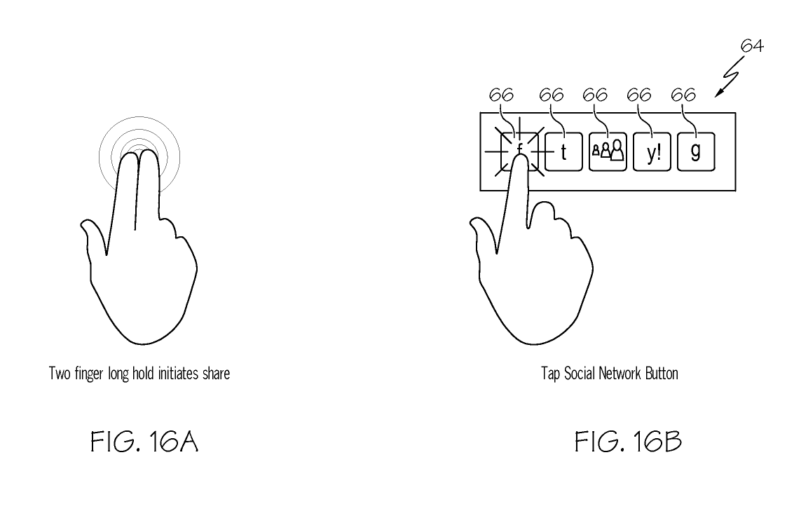

As a user is reading or viewing content, the user may wish to share the content, or portions thereof, and/or the identity of the content (i.e. its title, author, etc.), and/or certain viewing activities with others. This functionality, as well as the functionality described below, may be carried out by a sharing/social media module that is operatively connected to the reader and/or part of the reader/system/software. In one case, the user may indicate a desire to share content by use of a particular gesture using gesture-based logic/commands. In particular, as shown in FIG. 16A, when the device has a touch screen, the user can indicate a desire to share content by pressing two fingers over the content item, or an image or text corresponding to the content item, and holding the fingers in place.

In this case, the reader/social media module may be programmed to sense or recognize two spaced-apart touches which remain relatively stationary for a fixed period of time, or positioned over at least part of the content item for a fixed period of time, for example, at least about one second in one embodiment, or at least about ½ second, or at least about ¼ second. The reader/social media module may be programmed to sense two contact points which are spaced apart relatively close (i.e. spaced apart less than about ¼ inch but not more than one inch), and of a relative small area (i.e. each less than about ½ square inch in one case). Alternately, rather than looking for two spaced-apart points of contact, the reader/social media module may look for a sufficiently wide, stationary point of contact (i.e. a contact generally corresponding to the width of two fingers), particularly if the screen has relatively low sensitivity resolution.

An indication of a desire to share content or content identity can also be communicated by various other means such as other gesture-based logic/commands, navigating via a keyboard, using drop-down or pop-up menus, via a mouse, track ball, touch pad or other cursor control devices, keyboard shortcuts, etc. The navigation panel 16 of FIG. 2 may include a share icon 62 which can be selected to indicate a desire to share. In addition, the reader may display a “share” button overlaid, or positioned adjacent to, the content, when the content is displayed which can be selected by the user.

In any case, once the reader/social media module senses, and/or the user communicates the user's desire to share content, a sharing identity screen/pop-up 64 (FIG. 16B) may pop up listing various options, such as social media websites, social networks or social applications (collectively termed “social networks” herein), which a user can select for sharing. For example, FIG. 16B illustrates such a sharing identity window 64 with five buttons 66, each button 66 representing a particular social network. In the illustrated embodiment, the social networks are Facebook, Twitter, My Space, Yahoo Social Network and Google+. However, the number of social networks, and the particular social networks, can be varied as desired.

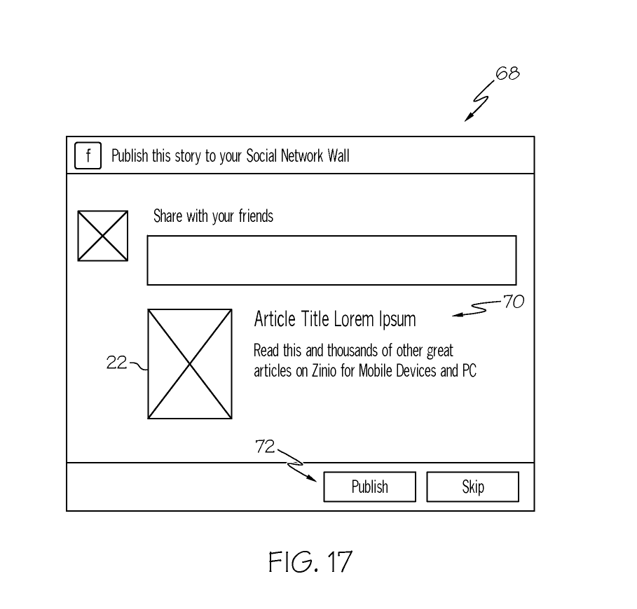

Once the user selects a particular social network(s), a sharing information window or social network window 68 may be presented to the user, as shown in FIG. 17. The sharing information window 68 identifies the title 70 of the content item, as well as an associated image 22. For example, in the embodiment shown in FIG. 17, the user has selected Facebook as a social network for sharing, and the sharing information window 68 enables the user to confirm a desire to share the content with Facebook friends, and select the particular Facebook friends for sharing.

Once the user selects the “Publish” button 72 of the sharing information window 68, the reader/social media module automatically forwards the associated information to the user's Facebook page. If the user is not logged into Facebook, the user may be prompted to log into Facebook, or the reader/social media module may automatically provide the Facebook application/website with appropriate log-in information. In any case, once the reader/social media module is able to post the information to the user's Facebook page, the reader/social media module may automatically post information, such as the identity of the article and an associated image, along with appropriate text (e.g. “James is reading this article”). The Facebook post may also include an invitation to others to purchase the content and/or forward the content to their friends. The user may be able to modify the automatically generated information before it is posted. In addition, depending upon the desires of the user and the particular set up for the reader, the reader may publish, or make available, the entire contents of the article/content, or an excerpt thereof, or provide a link to the article/contents. In some cases, when content is shared by a user, the number of friends who can view the entire article/contents, or parts thereof, may be limited (i.e. the article content may only be viewed/shared ten times, in one case)

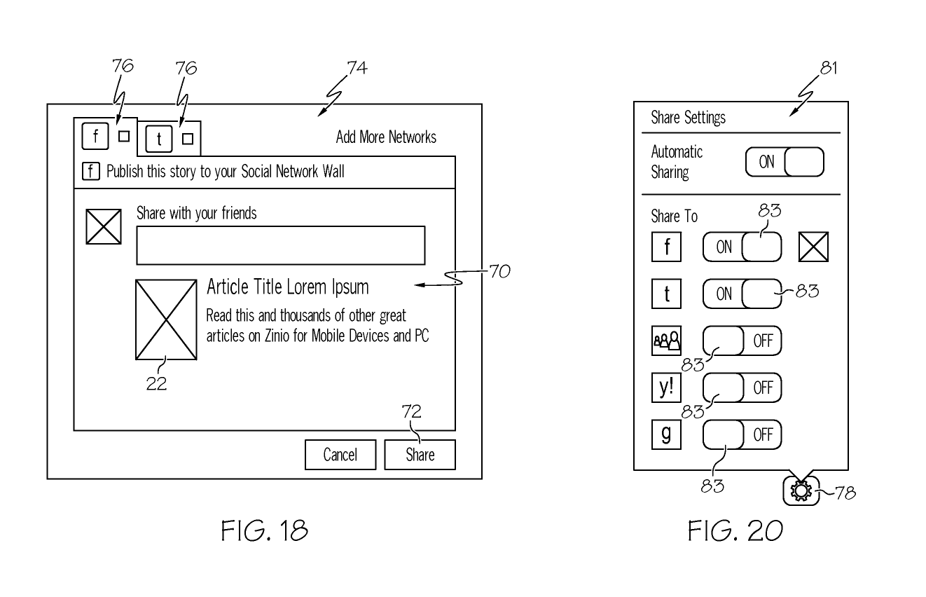

Alternately, rather than having the user first select the social media (i.e. in FIG. 16B) and then filling in fields in the sharing information window 68 (FIG. 17), after receiving an indication of a desire to share content, the user may be directed to an alternate sharing window 74, as shown in FIG. 18. This alternate sharing window or alternate social network window 74 is similar to the sharing information window 68 of FIG. 17. However, rather than first requiring the user to select which particular social networks are desired, a set of tabs 76 are provided at the top of the alternate social media window 74 to allow the user to select the desired social networks and enter the appropriate sharing details in a serial manner.

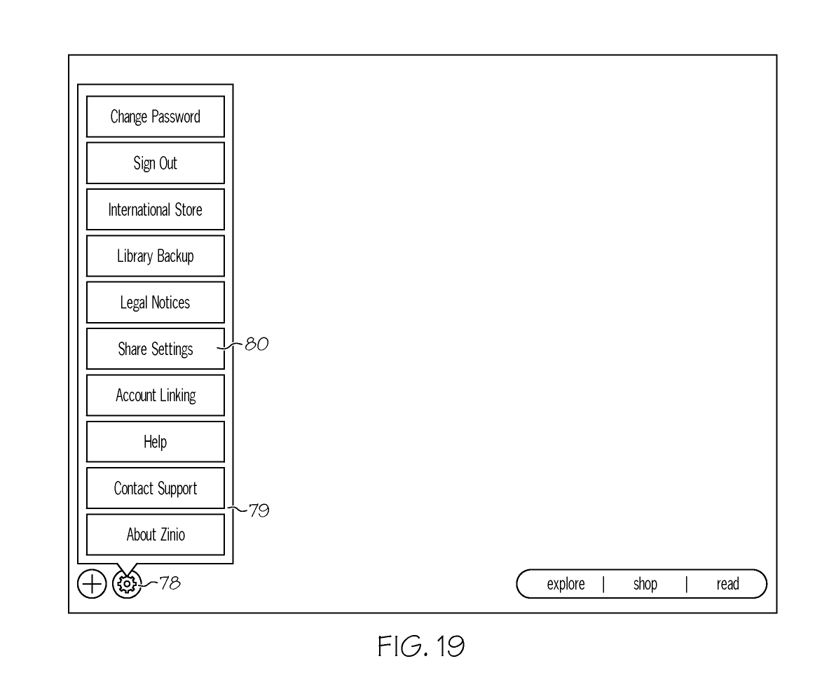

The reader/social media module may have a “share settings” function which enables the user to set up defaults for desired share settings. For example, as shown in FIG. 19, the reader/social media module may have or display an “option” icon 78 (also see FIG. 7) which, when selected/activated, provides a pop-up menu 79 (FIG. 19), including various user-selectable options. When a user selects the “share settings” icon or option 80 from the menu 79, a sharing settings window 81 (FIG. 20) is presented to the user. The sharing settings window 81 includes toggle-style slide selectors 83 allowing the user to select default share settings. In particular, as shown in FIG. 20, default sharing settings for Facebook and Twitter are turned “on,” whereas default sharing settings for My Space, Yahoo Social Network and Google+ are turned “off.” These settings may be particularly useful in conjunction with the alternate sharing information window 74 as shown in FIG. 18. In particular, when share setting for Facebook and Twitter are the only ones turned on, then the only tabs 76 displayed in the alternate sharing information window 74 are those for Facebook and Twitter. The share settings and preference can be stored on the user's device, or stored at the same server/computer as the reader, or stored at the same server/computer which provided the associated content, or stored elsewhere.

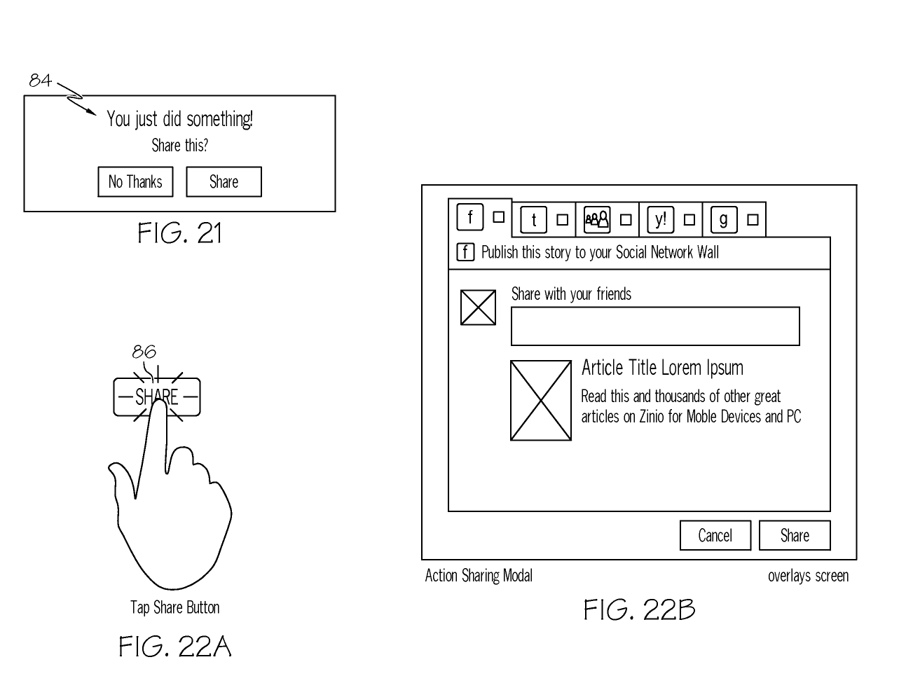

The reader/social media module may be configured to share other user activities with social networks. For example, each of the bookmarking, clipping and wishlisting activities outlined above can, if desired, be shared with social networks. For example, when a bookmark is created, a clipping is created, an item is added to a wishlist, or a user views, begins or finishes reading/viewing a content item, or undertakes other activities, a prompt window 84, as shown in FIG. 21, may automatically appear asking whether the user wishes to share the activity. If the user indicates “yes,” then the user may be presented with windows similar to the sharing information windows 68, 74 shown in FIG. 17 or 18, respectively. The reader/social media module may also display a “Share” button 86, as shown in FIG. 22A, at various locations (see, for example, FIG. 12) when content items are displayed, when the user is browsing or selecting content, or during other activities. When the share button 86 is selected, a sharing information 68, 74 window, or other analogous windows/pop-ups may appear. In addition, the user can activate sharing activities by any of a variety of other methods, such as by using drop-down or pop-up windows, keyboard shortcuts and the like.

If the activities are indicated by the user to be shared, then any of a wide variety of information may be provided to the social network for publication or sharing. For example, in the case of a bookmark, the identity of the content item 12, the date the bookmark was created, the user's name, any tags, comments or images, or combinations thereof, may be automatically provided to the social network by the reader/social media module. Similar information may be automatically provided relating to clipping and wishlist activities. Information about the user's activities can be provided to the social networks/application by a variety of means, and in one case the GIGYA™ Social Optimization Platform may be utilized.

The information presented to the social network, and treatment of such received information by the social network may vary. For example, when the social network is Twitter, then the information provided from the reader may be used to automatically generate a tweet stating the user's name/identity, the identity of the article, and other relevant information (i.e. a tweet in the form of “James has bookmarked the article ‘New Automobiles’ appearing in Luxury Cars Illustrated”). Of course, the content of the automatically generated content may be user-modifiable.

The reader/system/social media module thus enables a user to generate social media content so that the user's reading/viewing or other activities are automatically updated, in a passive sharing mode. Moreover, the user is provided with control so that the amount of auto-generated content is controlled and managed as desired. In addition, the user can exercise direct control to cause manually-directed sharing of activities and information as desired, in an active sharing mode.

Each of the functions described above may be provided or contained in its own module, as noted above. Each module can be a block of software, code, instructions or the like which, when run on a computer, provide the desired functions. Each module may be able to interact with the other modules, and may not necessarily be discrete and separate from the other modules, the reader, or other components of the reader/system. The software which carries out the system and methods disclosed herein, including the reader and/or modules, can take the form of one or more computer readable and/or executable instructions that cause a computer, device or the like to perform functions, actions and/or behave in a desired manner. The instructions may be embodied in various forms such as routines, algorithms, modules, methods, threads, and/or programs. The modules in the system may be functionally and/or physically separated, but can share data, outputs, inputs, or the like to operate as a single system and provide the functions described herein. For example, the reader can include a bookmark module which carries out the bookmark functions described above; a clipping module which carries out the clipping functions described above; a wishlist module which carries out the wishlist functions described above; and a sharing module which carries out the sharing functions described above; and a reader interface configured to cause content to be displayed on the screen of the device, such as by sending or delivering the content to the device in a manner which causes the content to be automatically displayed, in a manner familiar to those of ordinary skill in the art.

Although the invention is shown and described with respect to certain embodiments, it should be clear that modifications will occur to those skilled in the art upon reading and understanding the specification, and the present invention includes all such modifications.

What is claimed is:

1. A bookmarking system comprising:
a reader interface configured to cause content to be displayed on an electronic device having a touch-sensitive screen; and
a bookmark module configured to add a bookmark when a user swipes downwardly on the screen, wherein the bookmark is a record relating to the content displayed on the screen during the downward swipe.

2. The system of claim 1 wherein the bookmark is a record of the position of the content displayed on the screen during the downward swipe relative to other portions of the content.

3. The system of claim 1 wherein the bookmark module is configured to determine when the user swipes downwardly on the screen.

4. The system of claim 1 wherein the bookmark module is configured to add a bookmark only when the user swipes downwardly in an upper right quadrant of the screen.

5. The system of claim 1 wherein the bookmark module is configured to add a bookmark only when the user swipes downwardly on the screen with two fingers.

6. The system of claim 1 wherein the bookmark module is configured to display a bookmark icon on the relevant portion of the content displayed on the screen after the bookmark is added.

7. The system of claim 1 the bookmark module is configured to remove a previously-created bookmark when a user swipes upwardly on the screen displaying content corresponding to the previously-created bookmark.

8. The system of claim 1 wherein the bookmark module is configured to store the bookmark, and is configured such that when the bookmark is later selected by a user, the bookmark module causes the electronic device to display the content corresponding to the bookmarked location.

9. The system of claim 1 wherein the bookmark module is configured to store all the bookmarks created by the user.

10. The system of claim 9 wherein the bookmark module is configured to display all stored bookmarks, and at least one associated quality of each stored bookmark, upon receipt of an indication of a request by a user to view all of stored bookmarks.

11. The system of claim 1 wherein the bookmark module is configured to display a bookmark creation window when the user swipes downwardly on the screen, wherein the bookmark creation window has a title field in which a title of the content with which the bookmark is to be associated is enterable, and a comment field in which user comments relating to the bookmark are enterable.

12. The system of claim 1 further comprising the electronic device having the touch-sensitive screen, wherein the bookmark module takes the form of software stored in the electronic device.

13. The system of claim 1 wherein the reader interface and the bookmark module both comprise software embodied in a tangible computer-readable medium.

14. A content display system comprising:
a bookmark module configured to interface with an electronic device having a touch-sensitive screen configured to electronically display content thereon, the bookmark module being configured to add a bookmark when a user swipes downwardly on the screen, wherein the bookmark is a record relating to the content displayed on the screen during the downward swipe.

15. A bookmarking method comprising:
causing content to be displayed on an electronic device having a touch-sensitive screen;
recognizing user-generated input when a user swipes downwardly on the screen; and
in response to the user-generated input, creating a bookmark corresponding to the position of content displayed on the screen during the recognizing step.

16. A computer readable storage medium storing instructions readable by an electronic device having a touch-sensitive screen and including:
instructions for causing content to be displayed on the electronic device; and
instructions for causing a bookmark to be added when a user swipes downwardly on the screen, wherein the bookmark relates to the content displayed on the screen during the downward swipe.

17. A clipping system comprising:
a reader interface configured to cause content to be displayed on an electronic device having a touch-sensitive screen; and
a clipping module configured to clip a portion of content displayed on the screen when a user forms a generally closed loop on the screen about the clipped content.

18-34. (canceled)

35. A wishlisting system comprising:
a reader interface configured to cause content to be displayed on an electronic device having a touch-sensitive screen; and
a wishlist module configured to store an identifier of a content item when a user identifies the desired content item using the touch-sensitive screen.

36-48. (canceled)

49. A social network interface system comprising:
a reader interface configured to cause content to be displayed on an electronic device; and
a social network module configured to, when a user carries out at least one predetermined activity, automatically query a user about sending information relating to the displayed content to a social network, or to automatically send information relating to the displayed content to a social network.

50-66. (canceled)
